(19) United States
(12) Patent Application Publication
(10) Pub. No.: US 2015/0140422 A1
(43) Pub. Date: May 21, 2015

(54) MIXED ELECTROLYTES FOR HYBRID MAGNESIUM-ALKALI METAL ION BATTERIES

(71) Applicant: Battelle Memorial Institute, Richland, WA (US)

(72) Inventors: Tianbiao Liu, Richland, WA (US); Jun Liu, Richland, WA (US); Xilin Chen, Richland, WA (US); Yuyan Shao, Richland, WA (US); Guosheng Li, Richland, WA (US); Jiguang Zhang, Richland, WA (US)

(73) Assignee: Battelle Memorial Institute

(21) Appl. No.: 14/577,058

(22) Filed: Dec. 19, 2014

Related U.S. Application Data
(63) Continuation-in-part of application No. 14/084,075, filed on Nov. 19, 2013.

(51) Int. Cl. H01M 10/0568; H01M 4/485; H01M 4/58; H01M 10/054

(52) U.S. Cl. CPC H01M 10/0568; H01M 10/054; H01M 4/485; H01M 4/5825; H01M 2300/0025
USPC 429/200; 429/188; 429/199

(57) ABSTRACT

Embodiments of an electrolyte for a hybrid magnesium-alkali metal ion battery are disclosed. The electrolyte includes a magnesium salt, a Lewis acid, and an alkali metal salt. Embodiments of battery systems including the electrolyte also are disclosed.

### CROSS-REFERENCE TO RELATED APPLICATIONS

This application is a continuation-in-part of U.S. patent application Ser. No. 14/084,075, filed Nov. 19, 2013, which is incorporated herein in its entirety.

### ACKNOWLEDGMENT OF GOVERNMENT SUPPORT

This invention was made with government support under DE-AC0576RLO1830 awarded by the U.S. Department of Energy. The government has certain rights in the invention.

### FIELD

The invention concerns embodiments of a mixed magnesium-alkali metal electrolyte for use in a hybrid magnesium-alkali metal ion battery.

### BACKGROUND

Rechargeable magnesium (Mg) batteries have gained increasing attention as promising battery systems as an alternative to lithium-based batteries for grid-scale energy storage, powering portable devices and transportation applications. As an anode material, magnesium inherently possesses a number of advantages over lithium: it is safe to use (compared to lithium metal anodes), it does not form significant amounts of dendrites, it is earth abundant and low cost (about 24 times cheaper than lithium), and it has a high volumetric capacity (3832 Ah/L vs. 2062 Ah/L for Li) due to the divalent nature of the Mg^{2+/0} redox couple. In addition, Mg has a high reduction potential (−2.37 vs. SHE) amenable for assembling high voltage and high energy density batteries with suitable cathode materials.

Although the magnesium anode is highly attractive, the lack of compatible cathodes for Mg ion intercalation is one of the primary hurdles for developing practical rechargeable Mg-batteries. Additionally, magnesium metal anodes and magnesium intercalation anodes have electrode potentials that are approximately one volt higher than those of lithium. When coupled with a cathode, compared to lithium, the working voltage of magnesium cells is lower. This can mean that the energy density of magnesium batteries is also decreased.

A hybrid battery permits the use of other intercalating cathodes (e.g., alkali metal-ion intercalating cathodes), while taking advantage of the magnesium anode's merits. A major challenge for producing hybrid rechargeable magnesium-alkali metal ion batteries is the need for chemically and electrochemically reliable electrolytes. Existing electrolytes are chemically incompatible, meaning that components of the electrolyte may have undesirable side reactions with one another during storage and/or battery operation. For example, an electrolyte including LiBF₄ and C₆H₅MgCl suffers from a side reaction of nucleophilic attack by BF₄₋ on C₆H₅₋ ((Yagi, S. et al. J. Mater. Chem. A, 2014, 2, 1144-1149).

### SUMMARY

Embodiments of a mixed magnesium-alkali metal electrolyte and hybrid magnesium-alkali metal ion batteries including the electrolyte are disclosed.

Embodiments of an electrolyte for a hybrid Mg-alkali metal ion battery include a magnesium salt other than RMgX or MgR₂ wherein R is alkyl or aryl and X is halo, a Lewis acid, an alkali metal salt, and a solvent. In some embodiments, the magnesium salt is MgX₂, Mg(PF₆)₂, Mg(OR¹)₂, Mg(CF₃SO₃)₂, Mg(N(CF₃SO₃)₂)₂, Mg(ClO₄)₂, or a combination thereof, wherein X is halo and R¹ is aliphatic, aryl, alkoxy, aryloxy, thiolate, or amide.

In any or all of the above embodiments, the alkali metal salt may be MX, MPF₆, MAlCl₄, MB(C₂O₄)₄, MClO₄, MH₂PO₄, M(CF₃SO₃)₂, M(N(CF₃SO₃)₂)₂, M(BR²ₐX₄₋ₐ), M(AlR²ₐX₄₋ₐ), M(GaR²ₐX₄₋ₐ), M(AsR²ₐX₄₋ₐ), MCN, MSCN, or a combination thereof, where M is an alkali metal, X is halo, 0≦a≦4, and each R² independently is aliphatic, aryl, alkoxy, aryloxy, thiolate, or amide. In some embodiments, M is Li, Na, K, or a combination thereof.

In any or all of the above embodiments, the electrolyte may have a composition wherein 0.4 M≦[Mg]≦2 M, 0.4 M≦[alkali metal]≦3 M, or 0.4 M≦[Mg]≦2 M and 0.4 M≦[alkali metal]≦3 M. In any or all of the above embodiments, the electrolyte may have a composition wherein 0.4 M≦[Mg]+[alkali metal]≦5 M. In some embodiments, 0.4 M≦[Mg]≦2 M, 0.4 M≦[alkali metal]≦3 M, 0.8 M≦[Mg]+[alkali metal]≦5 M, or a combination thereof. In any or all of the above embodiments, the magnesium to alkali metal molar ratio may be in the range of from 0.5 to 2.

In any or all of the above embodiments, the Lewis acid may comprise a metal M′ and one or more supporting ligands comprising one or more halide anions X, one or more organic anions R³, or a combination thereof. In an independent embodiment, the metal M′ is B, Al, Ga, In, Fe, or a combination thereof. In another independent embodiment, each organic anion R³ independently is alkyl, aryl, alkoxide, aryloxide, thiolate, or amide. In another independent embodiment, the Lewis acid is M′R³_{z}X_{3-z}, where 0≦z≦3. In any or all of the above embodiments, the Lewis acid may be Al(C₆H₅)₃, AlCl₃, CH₃CH₂AlCl₂, GaCl₃, or a combination thereof.

In any or all of the above embodiments, the magnesium salt may be MgCl₂, the Lewis acid may be Al(C₆H₅)₃, CH₃CH₂AlCl₂, or a combination thereof, and the alkali metal salt may be LiCl, LiAlCl₄, NaCl, NaAlCl₄, or a combination thereof.

Embodiments of a rechargeable hybrid Mg-alkali metal ion battery system include (a) an electrolyte comprising (i) a magnesium salt other than RMgX or MgR₂ wherein R is alkyl or aryl, and X is halo, (ii) a Lewis acid, (iii) an alkali metal salt, and (iv) a solvent; (b) a magnesium anode; and (c) an alkali metal ion cathode. In some embodiments, the alkali metal ion cathode is a lithium ion cathode or a sodium ion cathode. In certain embodiments, the lithium ion cathode comprises Li₄Ti₅O₁₂, LiFePO₄, LiCoO₂, LiMn₂O₄, LiNiMnCoO₂, or LiNiCoAl₂. In such embodiments, the electrolyte may comprise (i) MgCl₂; (ii) Al(C₆H₅)₃, CH₃CH₂AlCl₂, or a combination thereof; and (iii) LiCl, LiAlCl₄, or a combination thereof. In certain embodiments, the sodium cathode comprises NaTiS₂, NaNi₂S₂, NaCu₂S, NaFeF₃, NaFePO₄, NaMnPO₄, NaCaPO₄, Na₃V₂(PO₄)₃, Na_{0.44}MnO₂, or NaNi_{0.5}Mn_{0.5}O₂. In such embodiments, the electrolyte may comprise (i) MgCl₂; (ii) Al(C₆H₅)₃, CH₃CH₂AlCl₂, or a combination thereof; and (iii) NaCl, NaAlCl₄, or a combination thereof.

The foregoing and other objects, features, and advantages of the invention will become more apparent from the following detailed description, which proceeds with reference to the accompanying figures.

### BRIEF DESCRIPTION OF THE DRAWINGS

FIG. 1 is a schematic cross-section of one embodiment of a rechargeable magnesium-alkali metal ion battery.

FIG. 2 is a series of cyclic voltammograms of exemplary electrolytes with magnesium salt, Lewis acid, and varying concentrations of alkali metal salt.

FIG. 3 is a series of cyclic voltammograms of exemplary electrolytes with varying concentrations of magnesium salt, Lewis acid, and alkali metal salt.

FIG. 4 shows repeated cyclic voltammograms of an exemplary electrolyte comprising 2 MgCl₂—AlPh₃ (0.5 M) and LiAlPh₃Cl (1.2 M).

FIG. 5 shows 30 cycles of charge and discharge data obtained at different charge rates for an exemplary hybrid Mg—Li ion cell including a Li₄Ti₅O₂ cathode, a magnesium anode, and an exemplary electrolyte comprising 0.2 M MgCl₂—AlCl₃ and 0.2 M LiAlCl₄ in THF.

FIG. 6 shows representative charge and discharge profiles for the hybrid Mg—Li ion cell of FIG. 5.

FIG. 7 shows representative charge and discharge profiles for an exemplary hybrid Mg—Li ion cell including a LiFePO₄ cathode, a magnesium anode, and an exemplary electrolyte comprising 2 MgCl₂—AlPh₃ (0.2 M) and LiAlCl₄ (0.4 M) in THF.

FIG. 8 shows charge and discharge data for the cell of FIG. 7 over 20 cycles.

### DETAILED DESCRIPTION

Embodiments of a mixed magnesium-alkali metal electrolyte for use in a hybrid magnesium-alkali metal ion battery are disclosed. The electrolyte comprises a magnesium salt, a Lewis acid, and an alkali metal salt. Hybrid magnesium-alkali metal ion batteries including embodiments of the electrolyte also are disclosed.

### I. Definitions and Abbreviations

The following explanations of terms and abbreviations are provided to better describe the present disclosure and to guide those of ordinary skill in the art in the practice of the present disclosure. As used herein, “comprising” means “including” and the singular forms “a” or “an” or “the” include plural references unless the context clearly dictates otherwise. The term “or” refers to a single element of stated alternative elements or a combination of two or more elements, unless the context clearly indicates otherwise.

Unless explained otherwise, all technical and scientific terms used herein have the same meaning as commonly understood to one of ordinary skill in the art to which this disclosure belongs. Although methods and materials similar or equivalent to those described herein can be used in the practice or testing of the present disclosure, suitable methods and materials are described below. The materials, methods, and examples are illustrative only and not intended to be limiting. Other features of the disclosure are apparent from the following detailed description and the claims.

Unless otherwise indicated, all numbers expressing quantities of components, percentages, temperatures, concentrations, and so forth, as used in the specification or claims are to be understood as being modified by the term “about.” Accordingly, unless otherwise indicated, implicitly or explicitly, the numerical parameters set forth are approximations that may depend on the desired properties sought and/or limits of detection under standard test conditions/methods as known to those persons of ordinary skill in the art. When directly and explicitly distinguishing embodiments from discussed prior art, the embodiment numbers are not approximates unless the word “about” is recited.

In order to facilitate review of the various embodiments of the disclosure, the following explanations of specific terms are provided:

Aliphatic: A substantially hydrocarbon-based compound, or a radical thereof (e.g., C₆H₁₃, for a hexane radical), including alkanes, alkenes, alkynes, including cyclic versions thereof, and further including straight- and branched-chain arrangements, and all stereo and position isomers as well. Unless expressly stated otherwise, an aliphatic group contains from one to twenty-five carbon atoms; for example, from one to fifteen, from one to ten, from one to six, or from one to four carbon atoms. The term “lower aliphatic” refers to an aliphatic group containing from one to ten carbon atoms. An aliphatic chain may be substituted or unsubstituted. Unless expressly referred to as an “unsubstituted aliphatic,” an aliphatic group can either be unsubstituted or substituted. An aliphatic group can be substituted with one or more substituents (up to two substituents for each methylene carbon in an aliphatic chain, or up to one substituent for each carbon of a —C═C— double bond in an aliphatic chain, or up to one substituent for a carbon of a terminal methine group). Exemplary substituents include, but are not limited to, alkyl, alkenyl, alkynyl, alkoxy, alkylamino, alkylthio, acyl, aldehyde, amide, amino, aminoalkyl, aryl, arylalkyl, carboxyl, cyano, cycloalkyl, dialkylamino, halo, haloaliphatic, heteroaliphatic, heteroaryl, heterocycloaliphatic, hydroxyl, oxo, sulfonamide, sulfhydryl, thioalkoxy, or other functionality.

Alkyl: A hydrocarbon group having a saturated carbon chain. The chain may be cyclic, branched or unbranched. The term lower alkyl means the chain includes 1-10 carbon atoms.

Alkoxy/alkyl oxide: A functional group having the formula RO— where R is alkyl.

Amido: A chemical functional group —C(O)N(R)(R′) where R and R′ are independently hydrogen, alkyl, heteroalkyl, haloalkyl, aliphatic, heteroaliphatic, aryl (such as optionally substituted phenyl or benzyl), heteroaryl, alkylsulfano, or other functionality.

Anode: An electrode through which electric charge flows into a polarized electrical device. In a discharging battery, the anode is the negative terminal where electrons flow out. When the anode is composed of a metal, electrons that it gives up to the external circuit are accompanied by metal cations moving away from the electrode and into the electrolyte. When the battery is recharged, the anode becomes the positive terminal where electrons flow in and metal cations are reduced.

Aryl: A monovalent aromatic carbocyclic group of, unless specified otherwise, from 6 to 15 carbon atoms having a single ring (e.g., phenyl) or multiple condensed rings in which at least one ring is aromatic (e.g., quinoline, indole, benzodioxole, and the like), provided that the point of attachment is through an atom of an aromatic portion of the aryl group and the aromatic portion at the point of attachment contains only carbons in the aromatic ring. If any aromatic ring portion contains a heteroatom, the group is a heteroaryl and not an aryl. Aryl groups are monocyclic, bicyclic, tricyclic or tetracyclic.

Aryloxy/aryl oxide: A functional group having the formula RO— where R is aryl.

Capacity: The capacity of a battery is the amount of electrical charge a battery can deliver. The capacity is typically expressed in units of mAh, or Ah, and indicates the maximum constant current a battery can produce over a period of one hour. For example, a battery with a capacity of 100 mAh can deliver a current of 100 mA for one hour or a current of 5 mA for 20 hours. The specific capacity of a battery or an electrode is the amount of electrical charge a battery or electrode can deliver per unit mass of the battery or electrode. The specific capacity is typically expressed in units of mAh/g, or Ah/kg, and indicates the maximum constant current a unique weight of battery or electrode can produce over a period of one hour. For example, an electrode with a specific capacity of 100 mAh/g can deliver a current of 100 mA/g for one hour or a current of 5 mA/g for 20 hours.

Cathode: An electrode through which electric charge flows out of a polarized electrical device. In a discharging battery, the cathode is the positive terminal where electrons flow in. Positive ions move from the electrolyte to the cathode, where they may be reduced. When the battery is recharged, the cathode becomes the negative terminal where electrons flow out and metal atoms are oxidized.

Cell: As used herein, a cell refers to an electrochemical device used for generating a voltage or current from a chemical reaction, or the reverse in which a chemical reaction is induced by a current. Examples include voltaic cells, electrolytic cells, redox flow cells, and fuel cells, among others. An electrochemical cell includes two half-cells. Each half-cell comprises an electrode and an electrolyte. A magnesium-alkali metal ion battery has a positive half-cell in which a cathode intercalating alkali metal ions is oxidized, and a negative half-cell in which magnesium ions are reduced during charge. Opposite reactions happen during discharge. Multiple single cells can form a cell assembly, often termed a stack. A battery includes one or more cells, or even one or more stacks. The terms “cell” and “battery” are used interchangeably when referring to a battery containing only one cell.

Coin cell: A small, typically circular-shaped battery. Coin cells are characterized by their diameters and thicknesses. For example, a type 2325 coin cell has a diameter of 23 mm and a height of 2.5 mm.

Current density: A term referring to the amount of current per unit area. Current density is typically expressed in units of mA/cm².

Electrolyte: A substance containing free ions that behaves as an ionically conductive medium.

Hybrid: As used herein, the term “hybrid” refers to a battery or cell having a magnesium anode and a cathode that intercalates alkali metal ions. The cathode may intercalate multiple ions, including alkali metal ions and Mg ions.

Lewis acid: A molecule or ion that is an electron pair acceptor; a molecule or ion that forms a covalent bond by accepting two electrons—a lone pair—from a second molecule or ion. Exemplary Lewis acids include, but are not limited to, H+, BF₃, and AlCl₃.

Nucleophile: An ion or molecule capable of donating an electron pair to an atomic nucleus (i.e., an electrophile) to form a covalent bond. The term “nucleophilic” means having an affinity for an atomic nucleus.

Thiolate: A functional group having the formula RS— where R is aliphatic or aryl.

### II. Electrolyte

Embodiments of the disclosed electrolyte for a hybrid Mg-alkali metal ion battery comprise a magnesium salt, a Lewis acid, and an alkali metal salt. Embodiments of the electrolyte further comprise a solvent. The electrolytes may consist essentially of, or consist of, a magnesium salt, a Lewis acid, an alkali metal salt, and a solvent. As used herein, “consists essentially of” means that the electrolyte may include other components that do not affect the performance of the magnesium-alkali metal ion battery during charging/discharging. Typical additives that do not affect the battery performance may include halide salts such as NH₄Cl or Et₄NCl.

Advantageously, the magnesium salt does not provide nucleophilic Mg²⁺ species when solvated by a solvent. Nucleophilic Mg²⁺ species may be chemically incompatible with Lewis acids, electrolyte solvents and even cathode materials, e.g., undesirable side reactions between the anions of the magnesium salt and the Lewis acid may occur in the electrolyte. Accordingly, the magnesium salts of the disclosed embodiments do not include RMgX or MgR₂ wherein R is alkyl or aryl and X is halo. For example, the magnesium salt is not C₆H₅MgCl. In an independent embodiment, the magnesium salt does not include a borohydride (BH₄₋) anion. Suitable magnesium salts include, but are not limited to, MgX₂, Mg(PF₆)₂, Mg(OR¹)₂, Mg(CF₃SO₃)₂, Mg(N(CF₃SO₃)₂)₂ (also known as Mg(TFSI)₂), Mg(ClO₄)₂, or a combination thereof, wherein X is halo and R¹ is aliphatic, aryl, alkoxy, aryloxy, thiolate, or amide. In some embodiments, the magnesium salt is MgX₂. In an independent embodiment, the magnesium salt is MgCl_{2.}

The disclosed electrolytes include a Lewis acid. The Lewis acid may comprise a metal M′ and one or more supporting ligands comprising one or more halide anions X, one or more organic anions R³, or a combination thereof. In some embodiments, the metal M′ is B, Al, Ga,

In, Fe, or a combination thereof. In an independent embodiment, the metal M′ is B, Al, or a combination thereof. In another independent embodiment, the metal is Al. Each organic anion R³ independently may be alkyl, aryl, alkoxide, aryloxide, thiolate, or amide. In an independent embodiment, R³ is alkyl, such as lower alkyl, or aryl. In another independent embodiment, R³ is ethyl or phenyl. In some embodiments, the Lewis acid has the formula M′R³_{z}X_{3-z}, where 0≦z≦3. In other words, the Lewis acid is M′X₃, M′R³X₂, M′R³₂X, M′R³₃, or any combination thereof. In an independent embodiment, the Lewis acid is AlR³_{z}X_{3-z} or BR³_{z}X_{3-z}. In some embodiments, the Lewis acid is M′X₃, M′R³X₂, M′R³₂X, M′R³₃, or any combination thereof, wherein R³ is alkyl, such as lower alkyl, or aryl. Exemplary Lewis acids include AlCl₃, Al(C₆H₅)₃ (AlPh₃), CH₃CH₂AlCl₂ (AlEtCl₂), AlCl₂C₆H₅, AlCH₃CH₂F₂, AlF₂C₆H₅, GaCl₃, GaCl₂CH₃CH₂, GaCl₂C₆H₅, BBr₂CH₃CH₂, BBr₂C₆H₅, and combinations thereof. In some embodiments, the magnesium salt is a magnesium halide, and the Lewis acid and magnesium halide comprise the same halogen. In an independent embodiment, the magnesium salt is MgCl₂ and the Lewis acid is AlPh₃ or AlEtCl₂.

Embodiments of the disclosed electrolytes include an alkali metal salt. Suitable alkali metal salts include, but are not limited to, MX, MPF₆, MAlX₄, MB(C₂O₄)₄, MClO₄, MH₂PO₄, M(CF₃SO₃)₂, M(N(CF₃SO₃)₂)₂, M(BR²ₐX₄₋ₐ), M(AlR²ₐX₄₋ₐ), M(GaR²ₐX₄₋ₐ), M(AsR²ₐX₄₋ₐ), MCN, MSCN, or a combination thereof, where M is an alkali metal; X is halo; 0≦a≦4; and each R² independently is aliphatic, aryl, alkoxy, aryloxy, thiolate, or amide. In one embodiment, the alkali metal salt does not include a borohydride anion. In an independent embodiment, the alkali metal salt is MX or MAlX₄. In another independent embodiment, the alkali metal salt is MCl, MAlCl₄, or a combination thereof. In another independent embodiment, the alkali metal salt is M(AlR²ₐX₄₋ₐ), such as LiAlPh₃Cl, or MPF₆, such as LiPF₆. In some embodiments, M is lithium, sodium, or potassium. In an independent embodiment, the alkali metal salt is LiCl, LiAlCl₄, NaCl, NaAlCl₄, or a combination thereof. For example, the alkali metal salt may be a combination of LiCl and LiAlCl₄, or a combination of NaCl and NaAlCl_{4.}

The magnesium salt and alkali metal salt may comprise the same anion, thereby avoiding anion metathesis to yield less soluble Mg salts such as, for example, [Mg₂Cl₃THF₆]AlCl₄ or [Mg₂Cl₃THF₆]PF₆. Thus, when the magnesium salt and alkali metal salt comprise the same anion, higher concentrations of the salts may be used compared to electrolytes in which the magnesium salt and the alkali metal salt comprise different anions. In some embodiments, the magnesium salt is a magnesium halide, and the magnesium salt and the alkali metal salt comprise the same halogen. In an independent embodiment, the magnesium salt is MgCl₂ and the alkali metal salt is LiCl, LiAlCl₄, NaCl, NaAlCl₄, or a combination thereof. In an independent embodiment, neither the magnesium salt nor the alkali metal salt comprises a borohydride anion.

In one embodiment, the electrolyte comprises (i) MgCl₂, (ii) Al(C₆H₅)₃ or CH₃CH₂AlCl₂, and (iii) LiCl, LiAlCl₄, NaCl, or NaAlCl₄. In an independent embodiment, the electrolyte consists essentially of, or consists of, (i) MgCl₂, (ii) Al(C₆H₅)₃, CH₃CH₂AlCl₂, or a combination thereof, (iii) LiCl, LiAlCl₄, NaCl, NaAlCl₄, or a combination thereof, and (iv) a solvent.

Embodiments of the disclosed electrolytes further comprise a solvent. Suitable solvents include, but are not limited to, tetrahydrofuran (THF), acetonitrile, ethers (e.g., dimethyl ether (DME), dibutyl ether), glycol ethers (e.g., glyme (dimethoxyethane), diglyme (2-methoxyethyl ether), triglyme (triethylene glycol dimethyl ether), tetraglyme (bis[2-(2-methoxyethoxy)ethyl] ether)), and combinations thereof. p The concentration of magnesium in the electrolyte (where the electrolyte comprises a magnesium salt, a Lewis acid, an alkali metal salt, and a solvent) is at least 0.2 M, such as from 0.2 M to 2 M, 0.4-2 M, 0.5-2 M, or 1-2 M. The concentration of alkali metal in the electrolyte is at least 0.2 M, such as from 0.2 M to 3 M. 0.4-3 M, 0.5-3 M, 1-3 M, or 1.2-3 M. In an independent embodiment, 0.4 M≦[Mg]≦2 M, 0.4 M≦[alkali metal]≦3 M, or 0.4 M≦[Mg]≦2 M and 0.4 M≦[alkali metal]≦3 M. In another independent embodiment, 0.5 M≦[Mg]≦2 M, 0.5 M≦[alkali metal]≦3 M, or 0.5 M≦[Mg]≦2 M and 0.5 M≦[alkali metal]≦3 M. In some embodiments, the combined concentration of magnesium and alkali metal in the electrolyte is at least 0.4 M, such as from 0.4 M to 5 M, from 0.5 M to 4 M, from 0.6 M to 4 M, from 0.6 M to 2.5 M, from 1 M to 2.5 M, or from 1 M to 2 M. In an independent embodiment, 0.4 M≦[Mg]≦2 M, or 0.4 M≦[alkali metal]≦3 M, or 0.8 M≦[Mg]+[alkali metal]≦5 M, or a combination thereof. In another independent embodiment, 0.5 M≦[Mg]≦2 M, or 0.5 M≦[alkali metal]≦3 M, or 1 M≦[Mg]+[alkali metal]≦5 M. In still another independent embodiment, 0.6 M≦[Mg]≦2 M, or 0.5 M≦[alkali metal]≦3 M, or 1.1 M≦[Mg]+[alkali metal]≦5 M.

In some embodiments, the electrolyte has a magnesium to alkali metal molar ratio in the range of from 0.5 to 2, such as a ratio from 0.5 to 1.5 or from 0.7 to 1.2.

The electrolyte may be prepared in a one-pot reaction or in a two-step reaction as shown in exemplary Schemes 1(a) and 1(b), respectively. The reaction products of the magnesium salt, the Lewis acid, the alkali metal salt, and/or the solvent can produce Mg²⁺ dimer monocations solvated by the solvent. The dimer cation can also be in an equilibrium with mono-Mg species, such as MgCl₂(THF)ₓ and/or [MgCl(THF)ₓ]+(2≦X≦5). The resulting electrolyte produced by either reaction comprises 2 MgCl₂—AlPh₃/LiAlPh₃Cl.

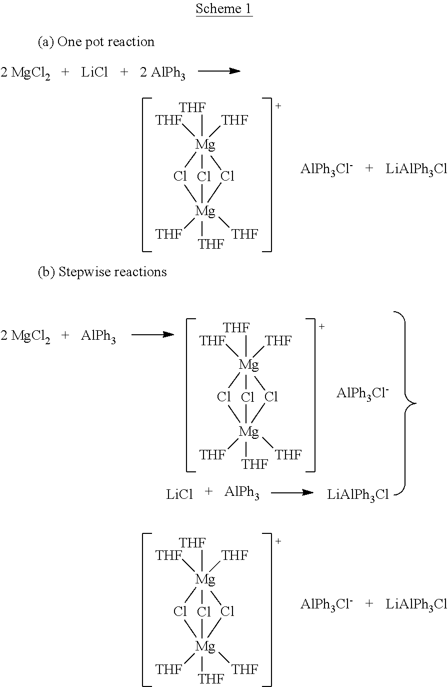

In both reactions, the magnesium and lithium salts are formed through mono-chloride abstraction. In a solvent comprising THF, two equivalents of MgCl₁₂ transfer one Cl⁻ to the Lewis acid (e.g., AlPh₃) and the resulting Mg₂Cl₃ core can complex with six THF molecules to form a [(μ-Cl )₃Mg₂(THF)₆]⁺ cation or the co-existing MgCl₂(THF)ₓ and [MgCl(THF)ₓ]⁺ (2≦X≦5). Corresponding reactions may occur when the Lewis acid is AlR³_{z}X_{3-z} or BAlR³_{z}X_{3-z}, where 0≦z≦3, and R³ is alkyl, aryl, alkoxide, aryloxide, thiolate, amide, or any combination thereof.

Such Mg²⁺ dimer salts and [MgCl(THF)ₓ]⁺ are electrochemically active for Mg²⁺ cycling, and either or both of them are believed to be significant contributors to electrical activity. Embodiments of Mg²⁺ dimer electrolytes are characterized by exceptional oxidation stability (up to 3.4 V vs. Mg), improved electrophilic susceptibility, high current density (up to 32.7 mA/cm²) and reversible Mg²⁺ ion plating and stripping (up to 100% Coulombic efficiency).

Embodiments of the disclosed electrolytes are chemically and electrochemically stable, i.e., unwanted side reactions do not occur between components of the electrolyte solution during storage and/or battery operation. In some examples, MgCl₂—AlPh₃ electrolytes comprising LiCl, LiPF₆, LiBF₄, or LiAlCl₄ showed excellent chemical compatibility as evidenced by cyclic voltammetry. Chemical compatibility is demonstrated when the electrolyte is repeatedly cycled (e.g., for up to 100 cycles or more) without significant changes in the voltammogram. Cycling stability can be quantified by the coulombic efficiency. Some embodiments of the disclosed electrolytes have a coulombic efficiency of 90-100%, such as 95-100%, over 100 cycles. The combination of MgCl₂, AlEtCl₂, and LiAlCl₄ also demonstrated excellent chemical compatibility.

### III. Battery Systems

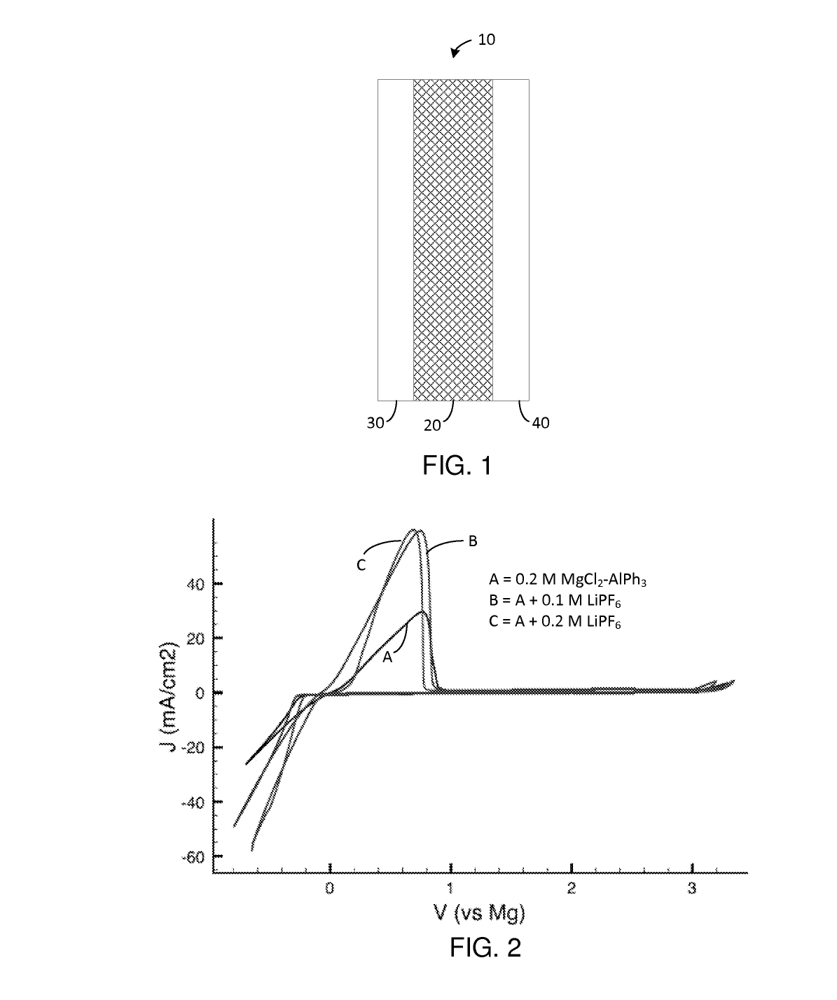

Embodiments of rechargeable hybrid Mg-alkali metal ion battery systems 10 include an electrolyte 20 as disclosed herein, a magnesium anode 30 and an alkali metal ion cathode 40 (FIG. 1). In some embodiments, the alkali metal ion cathode is a lithium ion cathode or a sodium ion cathode.

Suitable lithium ion cathodes include, but are not limited to, cathodes comprising Li₄Ti₅O₁₂(LTO), LiFePO₄ (LFP), LiCoO₂ (LCO), LiMn₂O₄ (LMO), LiNiMnCoO₂ (NMC), and LiNiCoAl₂ (LNC). Suitable sodium ion cathodes include, but are not limited to, NaTiS₂, NaNi₂S₂, NaCu₂S, NaFeF₃, NaFePO₄, NaMnPO₄, NaCaPO₄, Na₃V₂(PO₄)₃, Na_{0.44}MnO₂, and NaNi_{0.5}Mn_{0.5}O₂.

In an independent embodiment, a rechargeable hybrid Mg—Li ion battery system comprises a magnesium anode, a lithium ion cathode, and an electrolyte comprising (i) MgCl₂, (ii) LiCl, LiAlCl₄, or a combination thereof, and (iii) Al(C₆H₅)₃, CH₃CH₂AlCl₂, or a combination thereof. In an independent embodiment, a rechargeable hybrid Mg—Li ion battery system comprises a magnesium anode, a lithium ion cathode, and an electrolyte consisting essentially of, or consisting of, a solvent, (i) MgCl₂, (ii) LiCl, LiAlCl₄, or a combination thereof, and (iii) Al(C₆H₅)₃, CH₃CH₂AlCl₂, or a combination thereof. In an independent embodiment, a rechargeable hybrid Mg—Li ion battery system comprises a magnesium anode, a lithium ion cathode, and an electrolyte comprising (i) MgCl₂, (ii) LiCl, LiAlCl₄, or a combination thereof, and (iii) Al(C₆H₅)₃. In an independent embodiment, a rechargeable hybrid Mg—Li ion battery system comprises a magnesium anode, a LiFePO₄ cathode, and an electrolyte comprising MgCl₂, LiAlCl₄, and Al(C₆H₅)₃ in THF.

In an independent embodiment, a rechargeable hybrid Mg—Na ion battery system comprises a magnesium anode, a sodium ion cathode, and an electrolyte comprising (i) MgCl₂, (ii) NaCl, NaAlCl₄, or a combination thereof, and (iii) Al(C₆H₅)₃, CH₃CH₂AlCl₂, or a combination thereof. In another independent embodiment, a rechargeable hybrid Mg—Na ion battery system comprises a magnesium anode, a sodium ion cathode, and an electrolyte consisting essentially of, or consisting of, (i) a solvent, (ii) MgCl₂, (iii) NaCl, NaAlCl₄, or a combination thereof, and (iv) Al(C₆H₅)₃, CH₃CH₂AlCl₂, or a combination thereof.

Embodiments of the disclosed hybrid magnesium-alkali metal ion battery systems are rechargeable, have a greater voltage than magnesium batteries, have an improved cycling rate performance compared to magnesium batteries, and are safer than lithium batteries. Embodiments of the disclosed electrolytes allow use an alkali metal-ion intercalating cathode, thereby solving the prior problem of finding a suitable, compatible magnesium ion intercalating cathode. Some embodiments of the disclosed hybrid battery systems in which the alkali metal is lithium have a voltage of up to 4 V, such as a voltage from 2 V to 4 V. In comparison, a magnesium battery has a voltage of up to 1.2 V. The high voltage windows enable use of high rate/high capacity cathodes, such as LiFePO₄, LiCoO₂, LiMn₂O₄, LiNiMnCoO₂, and LiNiCoAl₂ cathodes.

Embodiments of the disclosed battery systems show consistent cell performance as indicated by substantially similar charge and discharge capacities (e.g., charge and discharge capacities that vary from one another by less than 10% or less than 5%) at different charge rates for at least 5 cycles, at least 10 cycles, at least 20 cycles, or at least 30 cycles. The charge capacity and/or the discharge capacity may vary by less than 50% over 20 cycles, by less than 30% over 15 cycles, by less than 20% over 10 cycles, or by less than 10% over 5 cycles. In some embodiments, the disclosed battery system has a substantially constant voltage while charging and a substantially constant voltage while discharging. For example, the voltage may vary by less than 10% over a specific capacity ranging from 10-100 mAh/g.

### IV. EXAMPLES

### Example 1

### Addition of Alkali Metal Salt to a Magnesium Salt-Lewis Acid Electrolyte

Electrolytes were prepared with MgCl₂, AlPh₃, and optionally LiPF₆ in tetrahydrofuran (THF). A suitable amount of MgCl₂, or a mixture of MgCl₂ and LiPF₆, was suspended in THF, and AlPh₃ solution (0.5-1 equivalent of MgCl₂) was added dropwise. The resulting solution was stirred for 5 hours. The solution can be directly used for electrochemical studies or can be dried as powders. Alternatively, the active Mg electrolytes can be prepared from MgCl₂ and AlPh₃ separately (as described in US 2014/0302404 A1) and then mixed with LiPF₆. Each electrolyte included 0.2 M MgCl₂—AlPh₃. The electrolytes included no LiPF₆, 0.1 M LiPF₆, or 0.2 M LiPF₆. Cyclic voltammograms were obtained at 22° C., at a scan rate of 50 mV/s, with a Pt working electrode. The electrolytes including the alkali metal salt exhibited a much greater current density, i.e., more than twice the current density of the electrolyte without the alkali metal salt (FIG. 2).

### Example 2

### Effect of Magnesium and Alkali Metal Ion Concentrations

Electrolytes were prepared with varying concentrations of MgCl₂, AlPh₃, and LiCl to form electrolytes comprising 2 MgCl₂—AlPh₃ or 2 MgCl₂—AlPh₃/LiAlPh₃Cl in THF. It is understood that when the concentration of “2 MgCl₂—AlPh₃” is provided, the [Mg²⁺] is twice the stated molarity, e.g., 0.2 M 2 MgCl₂—AlPh₃ includes 0.4 M Mg²⁺. The following electrolytes were prepared in THF:
A: 0.2 M 2 MgCl₂—AlPh₃
B: 0.2 M 2 MgCl₂—AlPh₃/0.2 M LiAlPh₃Cl
C: 0.3 M 2 MgCl₂—AlPh₃/0.5 M LiAlPh₃Cl
D: 0.4 M 2 MgCl₂—AlPh₃/0.7 M LiAlPh₃Cl
E: 0.4 M 2 MgCl₂—AlPh₃/1.0 M LiAlPh₃Cl
F: 0.5 M 2 MgCl₂—AlPh₃/1.2 M LiAlPh₃Cl

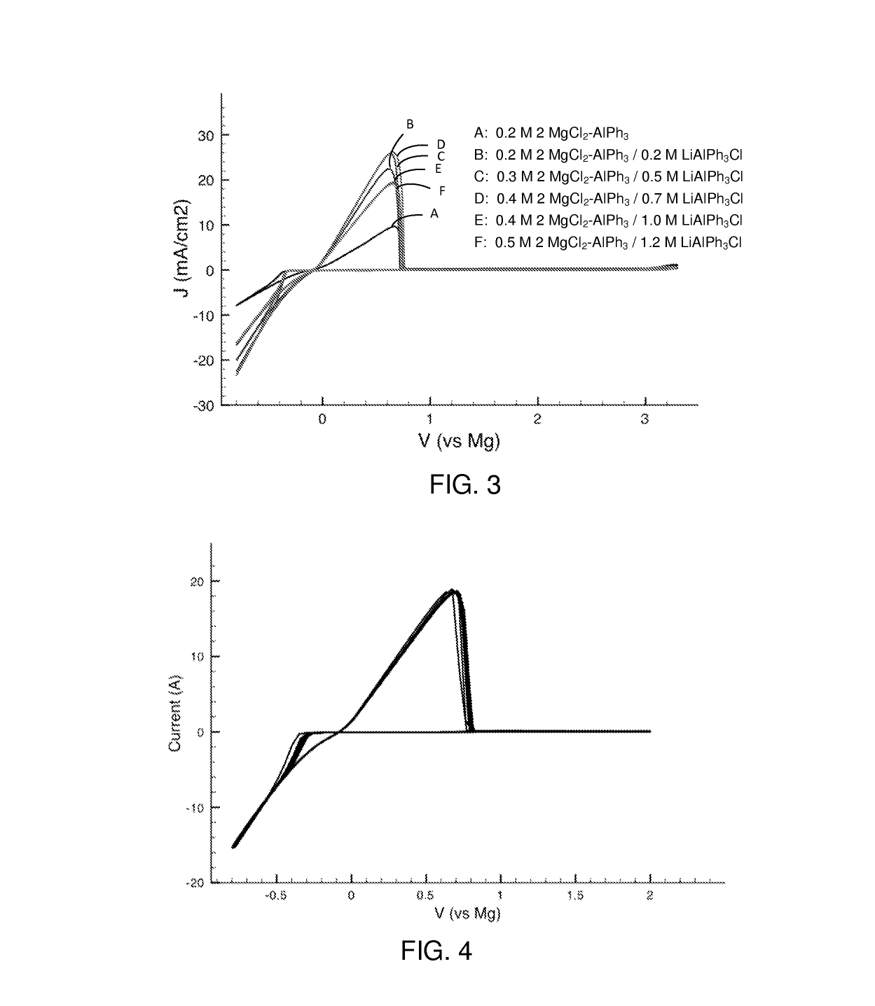

Cyclic voltammograms of each electrolyte were obtained at 22° C., at a scan rate of 50 mV/s, with a Pt working electrode. The results are shown in FIG. 3. As the electrolyte concentrations increased, current density increased until optimal current density occurred with electrolyte D—0.4 M 2 MgCl₂—AlPh₃/0.7 M LiAlPh₃Cl—having a combined Mg²+and Li⁺ concentration of 1.5 M, and a current density of 24 mA/cm². Further increased concentrations of both Mg and Li salts did not further increase current density, which might be due to increased viscosities of the resulting electrolytes.

All of the electrolytes exhibited excellent electrochemical reversibility for Mg deposition and stripping. FIG. 4 shows repeated cyclic voltammograms (10 cycles) of 0.5 M 2 MgCl₂—AlPh₃/1.2 M LiAlPh₃Cl obtained at a scan rate of 50 mV/s, Pt working electrode, 22 ° C. The overlapping voltammograms indicate 100% coulombic efficiency for Mg cycling.

### Example 3

### Hybrid Mg—Li Ion Battery with Li₄Ti₅O₁₂ Cathode

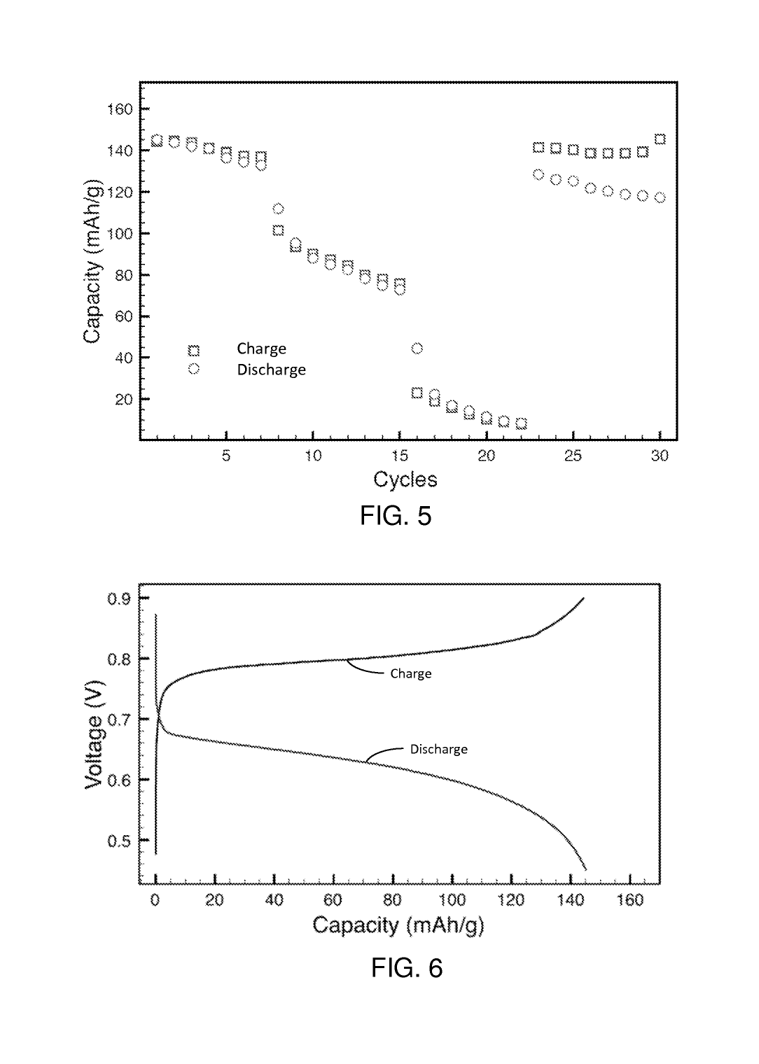

A coin cell including a Li₄Ti₅O₁₂ cathode, a magnesium plate anode, and an electrolyte comprising 0.2 M MgCl₂—AlCl₃ and 0.2 M LiAlCl₄ in THF was prepared. Cell cycling was performed at a charge rate of 0.1 C for cycles 1-7, 0.2 C for cycles 8-15, 0.4 C for cycles 16-22, and 0.1 C for cycles 23-30. The results are shown in FIG. 5.

FIG. 6 shows representative charge/discharge profiles of the cell. The cell exhibited steady plateaus at approximately 0.8 V for charging and 0.65 V for discharging.

### Example 4

### Hybrid Mg—Li Ion Battery with LiFePO₄ Cathode

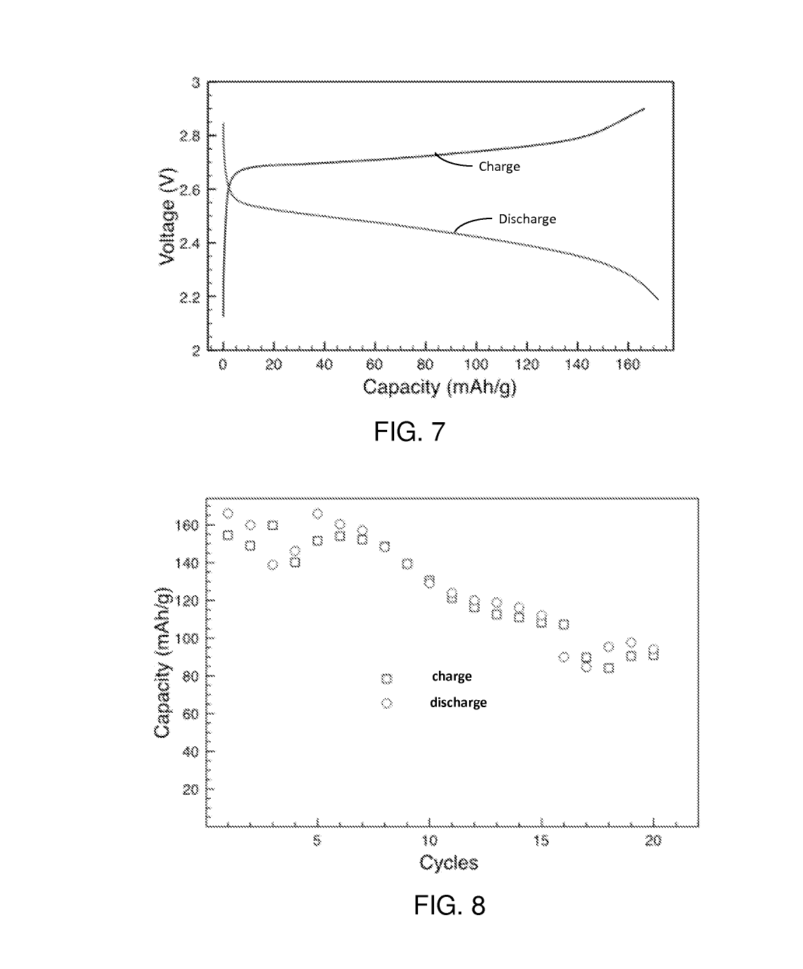

A custom-made cell was used for the following test. To match the stability of the electrolyte at the high oxidation potential of LiFePO₄ cathode (2.7 vs Mg), a carbon plate was used as a current collector for the cathode. Other traditional current collectors such stainless steel, Al, Ni or Cu can experience side reactions with the electrolytes above 2 V vs Mg. The cell also included a LiFePO₄ cathode, a magnesium plate anode, an ion conductive separator, and an electrolyte comprising 2 MgCl₂—AlPh₃ (0.2 M) and LiAlCl₄ (0.4 M) in THF. The LiFePO₄ cathode has a high oxidation potential of 2.7 V vs. Mg. FIG. 7 shows representative charge/discharge profiles of the cell. The cell exhibited steady plateaus at 2.7 V for charging and 2.5 V for discharging.

Cell cycling data is provided in FIG. 8. The data was obtained at a rate of 0.1 C. The cell capacity remained at approximately 160 mAh for the first 8 cycles. Gradual fading then occurred, which was attributed to a cell-sealing failure.

In view of the many possible embodiments to which the principles of the disclosed invention may be applied, it should be recognized that the illustrated embodiments are only preferred examples of the invention and should not be taken as limiting the scope of the invention. Rather, the scope of the invention is defined by the following claims. We therefore claim as our invention all that comes within the scope and spirit of these claims.

We claim:

1. An electrolyte for a hybrid Mg-alkali metal ion battery, the electrolyte comprising:
a magnesium salt other than RMgX or MgR₂ wherein R is alkyl or aryl and X is halo;
a Lewis acid;
an alkali metal salt; and
a solvent.

2. The electrolyte of claim 1, wherein the magnesium salt is MgX₂, Mg(PF₆)₂, Mg(OR¹)₂, Mg(CF₃SO₃)₂, Mg(N(CF₃SO₃)₂)₂, Mg(ClO₄)₂, or a combination thereof, wherein X is halo and R¹ is aliphatic, aryl, alkoxy, aryloxy, thiolate, or amide.

3. The electrolyte of claim 1, wherein the alkali metal salt is MX, MPF₆, MAlCl₄, MB(C₂O₄)₄, MClO₄, MH₂PO₄, M(CF₃SO₃)₂, M(N(CF₃SO₃)₂)₂, M(BR²ₐX₄₋ₐ), M(AlR²ₐX₄₋ₐ), M(GaR²ₐX₄₋ₐ), M(AsR²ₐX₄₋ₐ), MCN, MSCN, or a combination thereof, where
M is an alkali metal;
X is halo;
0≦a≦4; and
each R² independently is aliphatic, aryl, alkoxy, aryloxy, thiolate, or amide.

4. The electrolyte of claim 3, wherein M is Li, Na, K, or a combination thereof.

5. The electrolyte of claim 1, wherein:
0.4 M≦[Mg]≦2 M;
0.4 M≦[alkali metal]≦3 M; or
0.4 M≦[Mg]≦2 M and 0.4 M ≦[alkali metal]≦3 M.

6. The electrolyte of claim 1, wherein 0.4 M ≦[Mg]+[alkali metal]≦5 M.

7. The electrolyte of claim 6, wherein:
0.4 M≦[Mg]≦2 M;
0.4 M≦[alkali metal]≦3 M;
0.8 M≦[Mg]+[alkali metal]≦5 M; or
a combination thereof.

8. The electrolyte of claim 1, wherein the magnesium to alkali metal molar ratio is in the range of from 0.5 to 2.

9. The electrolyte of claim 1, wherein the Lewis acid comprises a metal M and one or more supporting ligands comprising one or more halide anions X, one or more organic anions R³, or a combination thereof.

10. The electrolyte of claim 9, wherein the metal M′ is B, Al, Ga, In, Fe, or a combination thereof.

11. The electrolyte of claim 9, wherein each organic anion R³ independently is alkyl, aryl, alkoxide, aryloxide, thiolate, or amide.

12. The electrolyte of claim 9, wherein the Lewis acid is M′R³_{z}X_{3-z}, where 0≦z≦3.

13. The electrolyte of claim 1, wherein the Lewis acid is Al(C₆H₅)₃, AlCl₃, CH₃CH₂AlCl₂, GaCl₃, or a combination thereof.

14. The electrolyte of claim 1, wherein:
the magnesium salt is MgCl₂;
the Lewis acid is Al(C₆H₅)₃, CH₃CH₂AlCl₂, or a combination thereof; and
the alkali metal salt is LiCl, LiAlCl₄, NaCl, NaAlCl₄, or a combination thereof.

15. A rechargeable hybrid Mg-alkali metal ion battery system, comprising:
an electrolyte comprising (i) a magnesium salt other than RMgX or MgR₂ wherein R is alkyl or aryl, and X is halo, (ii) a Lewis acid, (iii) an alkali metal salt, and (iv) a solvent;
a magnesium anode; and
an alkali metal ion cathode.

16. The battery system of claim 15, wherein the alkali metal ion cathode is a lithium ion cathode or a sodium ion cathode.

17. The battery system of claim 16, wherein the lithium ion cathode comprises Li₄Ti₅O₁₂, LiFePO₄, LiCoO₂, LiMn₂O₄, LiNiMnCoO₂, or LiNiCoAl₂.

18. The battery system of claim 17, wherein the electrolyte comprises:
MgCl₂;
Al(C₆H₅)₃, CH₃CH₂AlCl₂, or a combination thereof; and
LiCl, LiAlCl₄, or a combination thereof.

19. The battery system of claim 16, wherein the sodium ion cathode comprises NaTiS₂, NaNi₂S₂, NaCu₂S, NaFeF₃, NaFePO₄, NaMnPO₄, NaCaPO₄, Na₃V₂(PO₄)₃, Na_{0.44}MnO₂, or NaNi_{0.5}Mn_{0.5}O₂.

20. The battery system of claim 19, wherein the electrolyte comprises:
MgCl₂;
Al(C₆H₅)₃, CH₃CH₂AlCl₂, or a combination thereof; and
NaCl, NaAlCl₄, or a combination thereof.
